(19) United States
(12) Patent Application Publication
(10) Pub. No.: US 2005/0003143 A1
(43) Pub. Date: Jan. 6, 2005

(54) Composite formed from a film and a knitted or a non-woven fabric for hook-and-loop closures, in particular for disposable nappies

(75) Inventors: Jean-Pierre Ducauchuis, Nantes (FR); Thierry Marche, La Chapelle Basse Mer (FR)

Correspondence Address: Edward G. Greive;Renner, Kenner, Greive, Bobak, Taylor & Weber, Fourth Floor, First National Tower, Akron, OH, 44308-1456, US

(73) Assignee: APLIX

(21) Appl. No.: 10/870,824

(22) Filed: Jun. 17, 2004

(30) Foreign Application Priority Data
Jul. 4, 2003 (FR) 03 08201

(51) Int. Cl. B32B 3/02; B32B 33/00; D04B 1/22

(52) U.S. Cl. 428/92; 428/86; 442/312; 442/308

(57) ABSTRACT

Layered assembly or composite comprising a film and a knitted or non-woven fabric fixed on the film, the knitted fabric, or non-woven fabric, being formed from a base formed from threads, or from filaments, and from loops issuing from the base, characterised in that at least part of the threads, or filaments, of the base are anchored in the material of the film, and the film has a weight less than 20 g/m²,in particular between 5 and 15 g/m².

### TECHNICAL FIELD

The present invention relates to a method of producing a layered composite or assembly formed from a film, in particular of standard synthetic material, and from a knitted or a non-woven fabric, in particular a looped knitted or non-woven fabric, and to a composite or assembly obtained by this method. This type of layered assembly is used, in particular, for the production of female parts of a hook-and-loop closure, in particular in the area of disposable nappies.

### BACKGROUND ART

Layered assemblies of this type are already known for example, from French patent No. 95 14140 in the name of the applicant. In that case the knitted fabric is adhesively attached to the film either by depositing adhesive on the film, then placing the knitted fabric against the film, or by depositing adhesive on the back of the knitted fabric and then rolling it onto the film.

In the first case the problem arises that the loops which issue from the knitted fabric tend—during placement or calendering of the film against the knitted fabric—to come into contact the adhesive and to stick thereto. Once the loops are embedded in the adhesive which is then hardened they are then totally ineffective to hook into the hooks. In order to solve this problem the above-mentioned patent of the applicant makes provision to produce large loops, i.e. loops of a dimension such that they are partially protected by the threads forming the base of the knitted fabric and possibly the base of the adjoining loop.

In the second case, as described in French patent No. 9608259 in the name of the applicant, it is indeed possible to use small loops and an open-worked knitted fabric but the rate of production of the layered assembly is limited, in particular by reason of the application of the adhesive in strands in the form of a grid.

In one case as in the other it is necessary to use films which are resistant to being pulled in the direction of the machine in order to withstand the stretching associated with the calendering operation.

The document WO 99/14045 describes an assembly formed from a non-woven fabric and a film. The non-woven fabric is thermally fixed to the film by anchoring points, leaving a free space between them to permit the hooking of hook-and-loop closure hooks. Its production is complicated by this method of fixing by anchoring points, and for this reason the rate of production is also limited. Furthermore, because of the method of production it is necessary to use quite a heavy film. No more than 30% by length of the inner threads (on the film side) are in contact with the film.

### DISCLOSURE OF THE INVENTION

The present invention aims to obtain a layered composite or assembly as described above, intended to be used as the female part of a hook-and-loop closure which can have loops which are small in comparison with the pitch of the interlocking arrangement forming the base of the knitted fabric but without this affecting the capacity of the loops to hook into the hooks, in particular without the loops becoming embedded in the adhesive, and aims to achieve this at a high production rate.

In accordance with the invention the method of producing a layered assembly comprising a knitted or non-woven fabric and a film comprising the step which consists of causing a knitted or non-woven fabric to move forwards is characterised in that thermoplastic material is extruded onto the knitted or non-woven fabric which moves forward in order to form the film on the knitted or non-woven fabric, and of subjecting the composite formed from the knitted or non-woven fabric and thermoplastic material to an electrostatic field in order to anchor the film of thermoplastic material into the knitted or non-woven fabric.

In accordance with the invention the female part of a hook-and-loop closure comprising a layered assembly or composite formed from a film and a knitted fabric fixed on the film, the knitted fabric being formed from a base, formed from threads, and from loops issuing from the base, is characterised in that at least part of the threads of the base are anchored in the material of the film, and the film having a weight less than 20 g/m², in particular between 5 and 15 g/m².

In accordance with the invention there is now no longer a layer of adhesive or a grid of strands of adhesive between the knitted fabric and the film. In order to produce this layered assembly the film is extruded and bonded directly to the knitted fabric. This extrusion is carried out without pressure and by using static electricity so that the synthetic material forming the film coats, preferably partially coats, the threads of the base of the knitted fabric without coming into contact with the loops which are located therebelow. Thus once the synthetic material has hardened, the threads are partially anchored in the synthetic material without the loops having been touched. Thus loops are obtained which are free with respect to the interlocking arrangement of threads forming the base. This extrusion can be carried out at high speed and the absence of a calendering or pressing step means that the film used does not have to be thick in order to withstand these calendering or pressing operations, the thinness of the film thus reducing the cost of the composite.

The present invention also relates to a female part of a hook-and-loop closure comprising a layered assembly or composite formed from a film and a layer of non-woven fabric fixed to the film, the layer of non-woven fabric having a base, formed from the lowermost filaments of the layer, and loops formed from the other filaments thereof and from these other filaments and the lowermost filaments, characterised in that at least 30%, preferably more than 30% by length of the filaments of the base are anchored in the material of the film, the film having a weight less than 20 g/m², in particular between 5 and 15 g/m².

In accordance with the invention there is now no longer a layer of adhesive or grid of strands of adhesive between the non-woven fabric and the film. In order to produce this layered assembly the film is extruded and bonded directly to the non-woven fabric. This extrusion is carried out without pressure and by using static electricity so that the synthetic material forming the film coats, preferably partially coats, the filaments of the base without coming into contact with the loops which are located thereabove. Thus once the synthetic material has hardened, the filaments are partially anchored in the synthetic material without the loops having been touched. This extrusion can be carried out at high speed and the absence of a calendering or pressing step means that the film used does not have to be thick in order to withstand these calendering or pressing operations, the thinness of the film thus reducing the cost of the composite.

A material which adheres well to the material forming the threads of the base of the knitted or non-woven fabric is preferably used for the material of the film.

Preferably 20% to 60%, in particular 30% to 50% of the base is coated with the material of the film.

Thus extremely high resistance to delamination is achieved by means of a combination of chemical and mechanical fixing, without the loops being detrimentally affected.

According to a preferred embodiment of the invention the film is made from a material which can be printed. In accordance with the invention the film of the composite can be very thin. In fact rolls of layered assemblies which are longer for a given diameter than in the prior art are thus obtained.

In accordance with the invention in a preferred embodiment in the case where products are made which do not need to be printed or to be breathable the film can have a weight less than 10 g/m², in particular between 5 g/m² and 10 g/m².

According to a preferred embodiment of the invention the knitted or non-woven fabric has a weight less than 15 g/m², even less than 10 g/m². Very fine knitted or non-woven fabrics of this type are possible because the extrusion is carried out onto slightly taut knitted or non-woven fabrics, the cost of producing the composite thus being particularly low.

In accordance with a preferred embodiment of the invention the base is formed from an interlocking arrangement of weft threads and columns of stitches, and the loops are knitted into the interlocking arrangement.

In accordance with a preferred embodiment of the invention, the layered assembly comprises an outer layer or a plurality of outer layers, in particular an adhesive or self-adhesive layer, a layer to ensure greater mechanical holding or a layer to ensure impermeability to certain wavelengths.

The present invention also relates to a hook-and-loop closure comprising a part with hooks and a part with loops, the part with loops having a composite in accordance with the invention. The present invention also relates to a disposable nappy having a hook-and-loop closure in accordance with the invention.

### BRIEF DESCRIPTION OF THE DRAWINGS

A preferred embodiment of the invention will now be described with reference to the drawing in which:

FIG. 1 is a top view of a composite in accordance with the invention;

FIG. 2 is a side view of a part of a composite in accordance with the invention;

FIG. 3 is a view of a disposable nappy having a hook-and-loop closure, of which the looped part has a composite in accordance with the invention;

FIG. 4 is an overall view of an installation for producing a composite in accordance with the invention; and

FIG. 5 is a view equivalent to that of FIG. 2 in the case of a non-woven fabric.

### PREFERRED EMBODIMENT FOR CARRYING OUT THE INVENTION

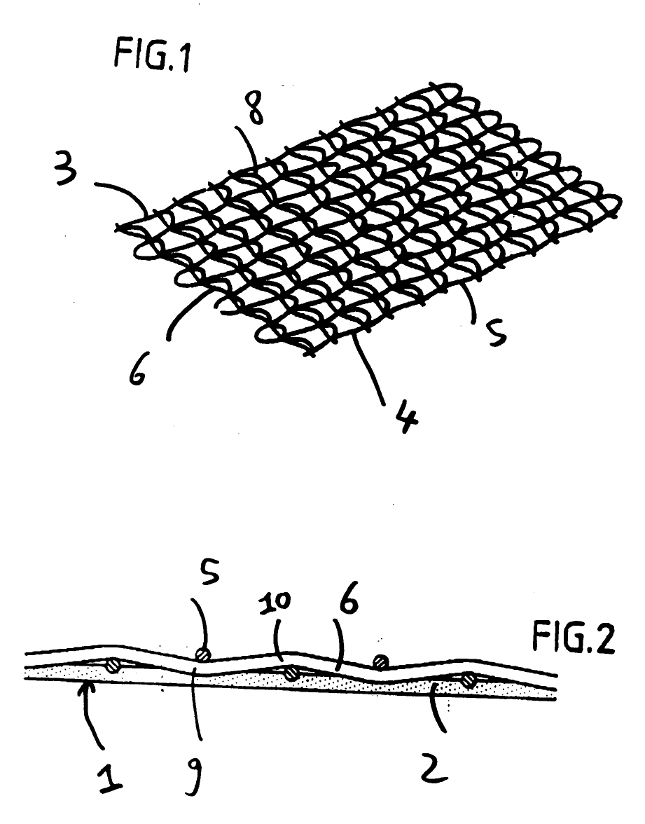

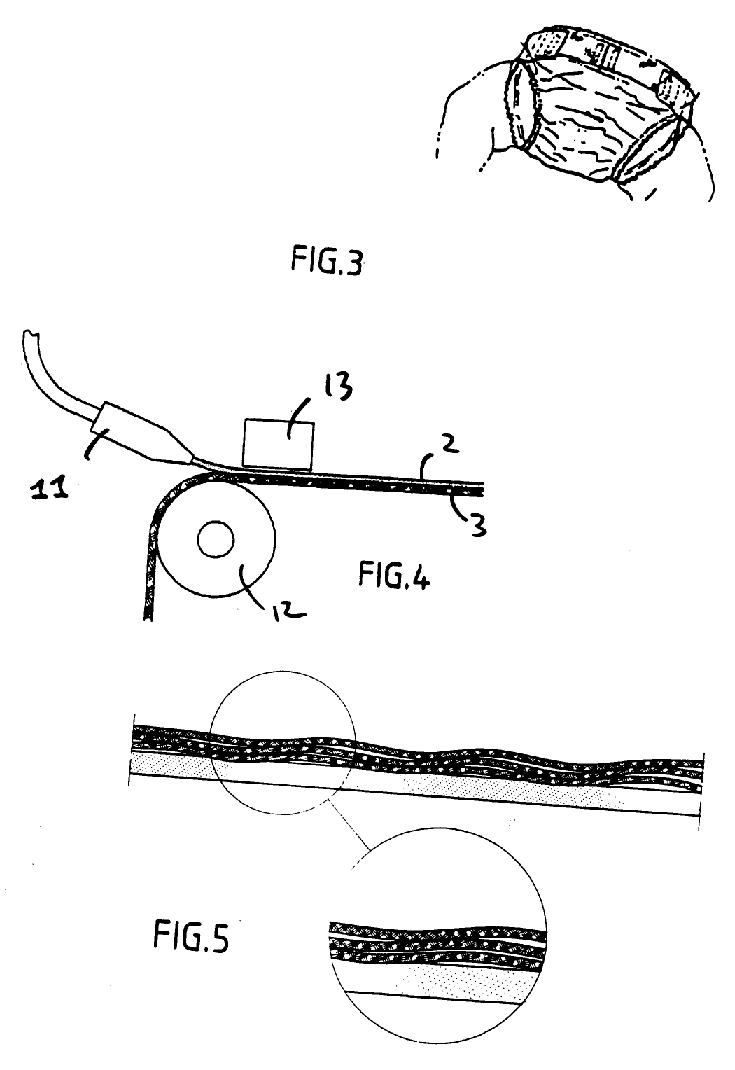

FIG. 1 shows a layered assembly 1 formed from a film 2 and from a knitted fabric 3. The knitted fabric 3 is made from a base 4 formed from an interlocking arrangement of warp threads 5 and columns of stitches 6. This interlocking arrangement forms a regular mesh with polygonal, four-sided stitches. Loops 8, also forming a mesh, are knitted into the interlocking arrangement of warp threads and columns of stitches. In this case the size of the loops is such that when they are laid flat against the base of the knitted fabric they are circumscribed by a stitch of the base. In fact it is not necessary to provide large loops, i.e. loops which are larger in size than the polygonal, four-sided stitch. However, if desired, large loops can, of course, be produced.

As shown in FIG. 2 (the loops are not shown therein for simplification) the threads 5, 6 of the interlocking arrangement of columns of stitches and weft threads are partially coated in the material of the film 2. One weft thread out of two is partially coated in the synthetic material forming the film, while the threads of the columns of stitches have an alternating arrangement of partially anchored sections 9 and free sections 10. As shown in FIG. 2, 50%, in transverse cross-section, of the circumference of the partially anchored weft threads is surrounded by the material, in particular synthetic material, of the film and 30% of the partially anchored sections are anchored in the material. Thus about 40% of all the threads forming the interlocking arrangement are anchored in the film. The film is made from synthetic material, in particular EVA, polypropylene, polyethylene or polyester. As far as the knitted fabric is concerned, the base can be of polyester, polyamide or polypropylene, while the loops can be of polyamide or polyester. These different materials have a good affinity in terms of adhesion so that the threads are well anchored in the material and are difficult to delaminate. Provision could also be made for the whole circumference of the thread to be embedded in the synthetic material. However, this may be slower to achieve and, when the material rises slightly too high, may cause certain loops also be to trapped in the material, which is undesirable. Consequently, it is preferable to regulate the pressure (or through-put) of the synthetic material extruded onto the knitted fabric so that the threads of the knitted fabric are only partially embedded in the synthetic material of the film.

Considered in terms of their length, the interlocking threads are at least in linear contact with the film over at least 30% of their longitudinal extension, in particular over at least 50% (in the case of the figure), preferably over at least 75%, for example over 100%.

Furthermore, it is possible to deposit an additional layer on the film of synthetic material. In particular this layer can be, for example, adhesive, in particular a thermo-reactivatable adhesive or a self-adhesive substance, in order to fix, for example, the layered assembly to a disposable nappy in order to form the female part of a hook-and-loop closure serving to close the disposable nappy. Of course, the layered assembly can quite simply also be adhesively attached without providing this additional layer. Another layer can also be provided simply to ensure greater rigidity in the assembly and thus better mechanical holding. It is also possible to provide a layer which is impermeable to certain wavelengths.

In order to extrude the film onto the knitted fabric, the synthetic material is conveyed by known means which are disposed, for example in the following order: 1. Metering/mixing system for the different synthetic materials, 2. Extruder with a specific screw, cooled or uncooled, 3. Extruder output filter, 4. Metering pump (optional), 5. Coating/extrusion die. The thickness of the extruded film is regulated by the through-put of material (and not in the usual manner by the geometry of the die).

The die 11 is preferably orientated to form an angle less than 45°, in particular from 15° to 25°, for example 22°, with a knitted fabric 3 on which the film 2 is deposited. The through-put of the material must be regulated so that the film obtained is carried away by the knitted fabric 3 which is driven by a roller 12. The height of the die with respect to the support can be regulated and is dependent upon the materials used, the angles used and the machine speed. It is 25 mm in order of magnitude.

An electrostatic charging system 13 of the ELTEX (30 KV/200 mm) type is used during cohesion in order to ensure the intimate contact between the film and the support. There is therefore no longer any calendering by mechanical pressure and this pressure-free system makes it possible not to adversely affect the intrinsic self-gripping characteristics of the constituent elements. A cooling zone can then be produced in order to stabilise the composite. The speed of the machine is usually 200 m/mn but can reach up to 500 m/mn.

The surface tension of the support can be treated (corona, plasma, flame treatment . . . ) if necessary in order to improve adhesion.

Instead of the knitted fabric 3 a non-woven fabric formed from entangled filaments can be provided, at least a part of the entangled arrangement in terms of its height being coated in the synthetic material of the film.

The non-woven fabric, formed from filaments entangled and amassed to form a layer, forms a base made from the filaments which are innermost or lowermost (on the film side), the other filaments (in the upper part of the layer) forming loops permitting hooks of a hook-and-loop closure to hook in.

The whole of the base is preferably in contact with, or is anchored in, the film.

When considered in terms of the longitudinal extension of the filaments of the base (the lowermost filaments), at least 30% of the length of each filament forming the base is preferably in contact with, or is anchored in, the film, preferably at least 50%, more preferably at least 75%, in particular 100%.

1. Female part of a hook-and-loop closure comprising a layered assembly or composite formed from a film and a knitted fabric fixed to the film, the knitted fabric being formed from a base, formed from threads, and from loops issuing from the base, characterised in that at least part of the threads of the base are anchored in the material of the film, and the film has a weight less than 20 g/m², in particular between 5 and 15 g/m².

2. Female part as claimed in claim 1, characterised in that a material which adheres well to the material forming the threads of the base of the knitted fabric or the filaments forming the base of the non-woven fabric is used for the material of the film.

3. Female part as claimed in claim 1, characterised in that at least 20% to 60%, in particular 30% of the threads, or of the filaments, of the base are coated with the material of the film.

4. Female part as claimed in claim 1, characterised in that at least 20% to 60% of the threads or of the filaments, of the base are coated with the material of the film.

5. Female part as claimed in claim 1, characterised in that in the case where products are produced which do not need to be printed or to be breathable, the film has a weight less than 10 g/m², in particular between 5 g/m² and 10 g/m².

6. Female part as claimed in claim 1, characterised in that the knitted fabric, or the non-woven fabric, has a weight of less than 10 g/m².

7. Female part as claimed in claim 1, characterised in that the base is a knitted fabric formed from an interlocking arrangement of weft threads and columns of stitches, and the loops are knitted into the interlocking arrangement.

8. Female part as claimed in claim 1, characterised in that the layered assembly has an outer layer or a plurality of outer layers, in particular an adhesive or self-adhesive layer, a layer to ensure greater mechanical holding or a layer to ensure impermeability to certain wavelengths.

9. Disposable nappy comprising a hook-and-loop closure to close the nappy at the waist, having a female part as claimed in claim 1.

10. Female part of a hook-and-loop closure comprising a layered assembly or composite formed from a film and a layer of non-woven fabric fixed to the film, the layer of non-woven fabric having a base, formed from the lowermost filaments of the layer, and loops formed from the other filaments thereof and from these other filaments and the lowermost filaments, characterised in that at least 30%, preferably more than 30% by length of the filaments of the base are anchored in the material of the film, the film having a weight less than 20 g/m², in particular between 5 and 15 gm².

11. Female part as claimed in claim 10, characterised in that a material which adheres well to the material forming the threads of the base of the knitted fabric or the filaments forming the base of the non-woven fabric is used for the material of the film.

12. Female part as claimed in claim 10, characterised in that in the case where products are produced which do not need to be printed or to be breathable, the film has a weight less than 10 g/m², in particular between 5 g/m² and 10 g/m².

13. Female part as claimed in claim 10, characterised in that the knitted fabric, or the non-woven fabric, has a weight of less than 10 g/m².

14. Female part as claimed in claim 10, characterised in that the base is a knitted fabric formed from an interlocking arrangement of weft threads and columns of stitches, and the loops are knitted into the interlocking arrangement.

15. Female part as claimed in claim 10, characterised in that the layered assembly has an outer layer or a plurality of outer layers, in particular an adhesive or self-adhesive layer, a layer to ensure greater mechanical holding or a layer to ensure impermeability to certain wavelengths.

16. Disposable nappy comprising a hook-and-loop closure to close the nappy at the waist, having a female part as claimed in claim 10.

17. Method for producing a female part of a hook-and-loop closure as claimed in claim 1, comprising the step which consists of causing a knitted or non-woven fabric to move forwards, characterised in that thermoplastic material is extruded onto the knitted or non-woven fabric which moves forward in order to form the film on the knitted or non-woven fabric, and of subjecting the composite formed from the knitted or non-woven fabric and thermoplastic material to an electrostatic field in order to anchor the film of thermoplastic material into the knitted or non-woven fabric.
